(19) United States
(12) Patent Application Publication
(10) Pub. No.: US 2026/0307143 A1
(43) Pub. Date: Oct. 8, 2026

(54) COPPER PASTE

(71) Applicant: MATERIAL CONCEPT, INC., Miyagi (JP)

(72) Inventor: Junichi KOIKE, Miyagi (JP)

(73) Assignee: MATERIAL CONCEPT, INC., Miyagi (JP)

(21) Appl. No.: 18/998,517

(22) PCT Filed: Aug. 10, 2023
(86) PCT No.: PCT/JP2023/029240

§ 371 Date: Jan. 26, 2025

(30) Foreign Application Priority Data
Aug. 10, 2022 (JP) 2022-128466

(51) Int. Cl. B22F 1/107; B22F 1/052; B22F 1/054; B22F 1/16

(52) U.S. Cl. CPC B22F 1/107; B22F 1/052; B22F 1/056; B22F 1/16; B22F 2301/10

(57) ABSTRACT

A copper paste according to the present invention contains copper powder and an alcohol solvent, where the alcohol solvent contains a first alcohol composed of at least one type of alcohol selected from the group comprising monohydric alcohols and dihydric alcohols, which has a viscosity of 3 mPa·s or more and 70 mPa·s or less at 25° C.; and a second alcohol composed of at least one type of dihydric alcohols and trihydric alcohols, which has a viscosity of 300 mPa·s or more and 1000 mPa·s or less at 25° C., and the viscosity of η₁₀ at a shear rate of 10 s⁻¹ at 25° C. is 1 Pa·s or more and 50 Pa·s or less, and the square root of √σ₀ of the Casson yield stress of σ₀ is 10 Pa^{1/2} or less.

### TECHNICAL FIELD

This invention relates to copper paste.

### BACKGROUND ART

Power modules are constructed by bonding a semiconductor element for controlling electrical power, an insulating heat-dissipation substrate, and the respective components for the cooling fins. Among these, materials such as Si, SiC, GaN, and Ga₂O₃ are used for the semiconductor element. For the insulating heat-dissipation substrate, ceramics with excellent thermal conductivity, such as Al₂O₃, AlN, and Si₃N₄ are used. Additionally, Al is commonly used for the cooling fins. To bond the respective components, a surface of the semiconductor element to be bonded is coated with thin metal films such as Cu, Ni, and Ag, and a surface of the insulating heat-dissipation substrate to be bonded is formed with a Cu thin plate using techniques known as Direct Bonding of Copper (DBC) or Active Metal Brazing (AMB). Furthermore, an additional Ag thin film may be formed on the surface of the Cu thin plate.

Bonding a semiconductor element to an insulating heat dissipation substrate is generally referred to as “die bonding.” The die bonding process involves a coating process for applying a conductive paste to the surface of a Cu thin film formed on the insulating heat dissipation substrate using methods like screen printing method or dispensing method, a drying process for drying the paste, a die mounting process for placing a semiconductor element onto the area where the conductive paste was applied, and a press sintering process for heating the conductive paste while applying a pressure of approximately 20 MPa in the lamination direction of the obtained laminate, so as to form a metal thin film as a sintered body of the conductive paste on the surface of the semiconductor element, thereby bonding/joining the same. Typical sintering conditions include heating at 250-300° C. for 3-10 minutes, and the atmosphere used during sintering may include air, nitrogen, hydrogen, or other gases depending on the paste used. The bonding strength of the die bonding formed through this process is required to have a die shear strength of at least 30 MPa.

The sintered body formed from the conductive paste exhibits excellent thermal conductivity, allowing heat generated during the operation of the semiconductor element under high voltage and high current conditions to be efficiently transferred to the insulating heat-dissipation substrate and dissipated from the cooling fins. Traditionally, high-lead-content solder paste has been used as the paste for die bonding; however, to accommodate the increasing operating temperatures of devices, silver paste with superior thermal conductivity has replaced it, and more recently, attention has turned to copper paste, which enables further cost reduction.

However, when copper paste is press-sintered under the aforementioned sintering conditions, the temperature is low and the time is short compared to normal sintering conditions, and as a result, it is not fully sintered, making it difficult to achieve the die shear strength required for the product. To promote sintering, it has been proposed to use fine copper particles with a large surface area to produce the paste.

For example, in Non-Patent Document 1, it is proposed to use copper nanoparticles with an average particle size of 50-60 nm, obtained by reducing a mixed solution of copper hydroxide and nitrilotriacetic acid disodium salt with hydrazine, in copper paste. This copper paste forms a sintered body by heating at 200° C. for 30 minutes in a nitrogen atmosphere, and the die shear strength of the die bond is reported to be a maximum of 39 MPa.

### PRIOR ART REFERENCES

### Non-Patent Literature

1: Y. Kamikoriyama, H. Imamura, A. Muramatsu, K. Kanie, Sci. Rep., 9,899 (2019).

### SUMMARY OF THE INVENTION

### Problems to be Solved by the Invention

However, as in Non-Patent Document 1, when the particles are made finer, the particles tend to agglomerate, which can lead to the formation of holes, protrusions, or cracks after the coating and drying processes. These defects are carried over into the bonded body after the press sintering process, potentially causing a reduction in die shear strength. Additionally, when the particles are finely divided, the specific surface area increases, and during storage of the copper particles or the drying process after the copper paste is applied, the particle surfaces are prone to oxidation, leading to degrading of the sinterability, which in turn degrades the die shear strength and reduces the required thermal conductivity for heat dissipation.

The present invention has been made in view of the above circumstances, and an object of the present invention is to provide a copper paste that has excellent oxidation resistance and superior die shear strength in the resulting sintered body.

### Means for Solving the Problems

The inventors of the present invention conducted intensive studies to solve the aforementioned problems. As a result, it was found that a copper paste containing copper powder and an alcohol solvent, where the alcohol solvent contains a first alcohol selected from a group including monohydric alcohols and dihydric alcohols, which has a viscosity of 3 mPa·s or more and 70 mPa·s or less at 25° C. and a second alcohol selected from a group including dihydric alcohols and trihydric alcohols, which has a viscosity of 300 mPa·s or more and 1000 mPa·s or less at 25° C., wherein the viscosity of η₁₀ at a shear rate of 10 s⁻¹ at 25° C. is 1 Pa·s or more and 50 Pa·s or less, and the square root of √σ₀ of the Casson yield stress of σ₀ is 10 Pa^{1/2} or less, results in a copper paste with excellent oxidation resistance and superior die shear strength in the resulting sintered body, leading to the completion of the present invention. In other words, the present invention provides the following.

(1) A copper paste comprising copper powder and an alcohol solvent, wherein the alcohol solvent contains: a first alcohol composed of at least one type of alcohol selected from the group comprising monohydric alcohols and dihydric alcohols, which has a viscosity of 3 mPa·s or more and 70 mPa·s or less at 25° C.; and a second alcohol composed of at least one type of dihydric alcohols and trihydric alcohols, which has a viscosity of 300 mPa·s or more but 1000 mPa·s or less at 25° C., and wherein the viscosity of η₁₀ at a shear rate of 10 s⁻¹ at 25° C. is 1 Pa·s or more and 50 Pa·s or less, and the square root of √σ₀ of the Casson yield stress of 00 is 10 Pa^{1/2} or less.

(2) The copper paste according to the above (1), wherein the square root of √η_{∞} of the Casson viscosity of no is 1 Pa·s^{1/2} or less.

(3) The copper paste according to the above (1) or (2), wherein the copper powder further comprises: first copper particles which have an average particle diameter of 50 nm or more and 900 nm or less, second copper particles which have an average particle diameter of 150 nm or more and 1 μm or less, which is at least 100 nm larger than the average particle diameter of the first copper particle, and third copper particles that are in a plate-shape, a scaly shape, a flat-shape, or a flaky shape and have an average particle diameter of 1.5 μm or more and 20 μm or less.

(4) The copper paste according to the above (3), wherein the copper powder contains, relative to 100 mass % of the copper powder, 1 mass % or more and 30 mass % or less of the second copper particles, and 5 mass % or more and 60 mass % or less of the third copper particles.

(5) The copper paste according to the above (1) or (2), wherein the total amount of the first alcohol and the second alcohol is 5 mass % or more and 50 mass % or less, relative to the total mass of the copper powder, the first alcohol, and the second alcohol, which is 100 mass %.

(6) The copper paste according to the above (1) or (2), wherein the paste contains no resin or contains resin in an amount of more than 0 mass % and 10 mass % or less, relative to 100 mass % of the copper powder.

(7) The copper paste according to the above (1) or (2), which does not contain a silane coupling agent that has an epoxy group and a silane coupling agent that has an amino group, or contains the silane coupling agent that has the epoxy group and the silane coupling agent that has the amino group in an amount of more than 0 mass % and 0.05 mass % or less, relative to 100 mass % of the copper powder.

(8) The copper paste according to the above (1) or (2), wherein the first alcohol contains one or more elements selected from the group comprising 1-hexanol, 1-heptanol, 2-heptanol, 1-octanol, 2-octanol, 2-ethyl-1-hexanol, benzyl alcohol, ethylene glycol, 1,2-propanediol, 1,3-propanediol, and 2,3-butanediol.

(9) The copper paste according to the above (3), wherein at least one of the first copper particles and the second copper particles has polysaccharides coated on at least a part of their surface.

(10) The copper paste according to the above (3), wherein at least one of the first copper particles and the second copper particles has one or more acids selected from the group comprising octanoic acid, nonanoic acid, decanoic acid, dodecanoic acid, and tetradecanoic acid on at least a part of its surface.

### Advantages of the Invention

According to the present invention, it is possible to provide a copper paste that has excellent oxidation resistance and superior die shear strength in the sintered body.

### BRIEF DESCRIPTION OF THE DRAWINGS

FIG. 1 is a Casson plot of the paste in Comparative Example 2 (η₁₀₌₁₈₅ Pa·s).

FIG. 2 is a Casson plot of the paste in Comparative Example 1 (η₁₀₌₁₁ Pa·s).

FIG. 3 is a Casson plot of the paste in Example 4 (η₁₀₌₈ Pa·s).

FIG. 4 is an optical microscope image of the dried product of the paste in Comparative Example 1.

FIG. 5 is an optical microscope image of the dried product of the paste in Example 4.

### EMBODIMENTS OF THE INVENTION

The embodiments of the present invention will be described below; however, the present invention is not limited to the description of these embodiments and can be implemented with appropriate modifications.

### <Copper Paste>

The copper paste according to this embodiment contains copper powder and an alcohol solvent. Among these, the alcohol solvent contains a first alcohol selected from a group comprising monohydric alcohols and dihydric alcohols, which has a viscosity of 3 mPa·s or more and 70 mPa·s or less at 25° C. and a second alcohol selected from a group comprising dihydric alcohols and trihydric alcohols, which has a viscosity of 300 mPa·s or more and 1000 mPa·s or less at 25° C., wherein the viscosity of η₁₀ at a shear rate of 10 s⁻¹ at 25° C. is 1 Pa·s or more and 50 Pa·s or less, and the square root of √σ₀ of the Casson yield stress of 00 is 10 Pa^{1/2} or less, results in a copper paste with excellent oxidation resistance and superior die shear strength in the resulting sintered body, leading to the completion of the present invention.

Regarding the viscosities of the first alcohol and the second alcohol, both of these alcohols are Newtonian fluids, meaning their viscosity does not depend on the shear rate, and therefore, the viscosity refers to the viscosity at any given shear rate.

In the case of copper paste, it is a non-Newtonian fluid, and therefore, the viscosity is measured using a cone-plate type dynamic shear rheometer (for example, a Brookfield RST Cone-Plate Rheometer), and it refers to the viscosity of the copper paste at a shear rate of 10 s⁻¹.

In the copper paste according to this embodiment, at least two types of alcohols are used together as organic solvents for the dispersion medium. This helps to suppress the oxidation of copper powder during storage and sintering. The resulting sintered body has a reduced amount of oxides present within it, resulting in excellent thermal conductivity and bonding strength.

In the copper paste according to this embodiment, the viscosity of η₁₀ at a shear rate of 10 s⁻¹ is 1 Pa·s or more and 50 Pads or less. By ensuring that the viscosity of η₁₀ at the shear rate of 10 s⁻¹ is above the required value, the paste can be prevented from seeping under the printing plate and forming a diffused form during application by the printing method. Additionally, it prevents the paste from flowing after application by dispensing method, maintaining the desired shape. Furthermore, by ensuring that the viscosity of η₁₀ is below the required value, during the die-mounting process, the paste can be uniformly distributed between the semiconductor element and the insulating heat dissipation substrate, sintering variations in respective portions of the pressure-sintered body can be suppressed, and the variations that depends upon the die shear strength can be suppressed.

The viscosity of η₁₀ at a shear rate of 10 s⁻¹ is not particularly limited as long as it is 1 Pa·s or more and 50 Pa·s or less; however, for example, it is preferable for the viscosity to be at 1.5 Pa·s or more, 2 Pa·s or more, 2.5 Pa·s or more, 3 Pa·s or more, 3.5 Pa·s or more, 4 Pa·s or more, 4.5 Pa·s or more, 5 Pa·s or more, 5.5 Pa·s or more, 6 Pa·s or more, 6.5 Pa·s or more, 7 Pa·s or more, 7.5 Pa·s or more, 8 Pa·s or more, 8.5 Pa·s or more, 9 Pa·s or more, 9.5 Pa·s or more, or 10 Pa·s or more. On the other hand, the viscosity of η₁₀ at a shear rate of 10 s⁻¹ is preferably at 49 Pa·s or less, 47 Pa·s or less, 45 Pa·s or less, 42 Pa·s or less, 40 Pa·s or less, 37 Pa·s or less, 35 Pa·s or less, 32 Pads or less, or 30 Pa·s or less.

In the copper paste according to this embodiment, the square root of √σ₀ of the Casson yield stress of 0, is 10 Pa^{1/2} or less. The square root of √σ₀ of the Casson yield stress of 00 is an indicator of the size and strength of agglomerates, and by ensuring that the square root of √σ₀ is below the required value, the agglomerates are prevented from becoming too large or strongly aggregated, which helps suppress the formation of holes or protrusions on the paste surface after drying, thereby preventing a reduction in the die shear strength after pressure sintering.

The square root of √σ₀ of the Casson yield stress of go is not particularly limited as long as it is 10 Pa^{1/2} or less; however, for example, it is preferable for the square root of √σ₀ to be 9.7 Pa^{1/2} or less, 9.5 Pa^{1/2} or less, 9.2 Pa^{1/2} or less, 9 Pa^{1/2} or less, 8.7 Pa^{1/2} or less, 8.5 Pa^{1/2} or less, 8.2 Pa^{1/2} or less, 8 Pa^{1/2} or less, 7.7 Pa^{1/2} or less, 7.5 Pa^{1/2} or less, 7.2 Pa^{1/2} or less, 7 Pa^{1/2} or less, 6.7 Pa^{1/2} or less, 6.5 Pa^{1/2} or less, 6.2 Pa^{1/2} or less, 6 Pa^{1/2} or less, 5.7 Pa^{1/2} or less, 5.5 Pa^{1/2} or less, 5.2 Pa^{1/2} or less, or 5 Pa^{1/2} or less.

In the copper paste according to the present embodiment, the Casson viscosity of no is not particularly limited, but its square root of √η_{∞} is preferably 1 (Pa·s^{1/2} or less, 0.97 (Pa·s)^{1/2} or less, 0.95 (Pa·s)^{1/2} or less, 0.92 (Pa·s)^{1/2} or less, 0.9 (Pa·s)^{1/2} or less, 0.87 (Pa·s)^{1/2} or less, 0.85 (Pa·s)^{1/2} or less, 0.82 (Pa·s)^{1/2} or less, 0.8 (Pa·s)^{1/2} or less, 0.77 (Pa·s)^{1/2} or less, 0.75 (Pa·s)^{1/2} or less, 0.72 (Pa·s)^{1/2} or less, 0.7 (Pa·s)^{1/2} or less, 0.67 (Pa·s)^{1/2} or less, 0.65 (Pa·s)^{1/2} or less, 0.62 (Pa·s)^{1/2} or less, 0.6 (Pa·s)^{1/2} or less, 0.57 (Pa·s)^{1/2} or less, 0.55 (Pa·s)^{1/2} or less, 0.52 (Pa·s)^{1/2} or less, or 0.5 (Pa·s)^{1/2} or less. The square root of √η_{∞} of the Casson viscosity of no can be used as an indicator of the ease of movement of the paste during the paste application process, and when √η_{∞} is below the required value, the paste can follow the movement of the squeegee more easily during screen printing, preventing defects in the paste application area and ensuring uniformity in the paste thickness.

### <Measurement of Dynamic Viscoelastic Behavior of Copper Paste>

The dynamic viscoelastic behavior of the copper paste was measured using a dynamic viscoelastic measurement device equipped with a cone-plate type spindle (for example, Brookfield's RST Cone Plate Rheometer), where the viscosity of the copper paste at a shear rate of 10 s⁻¹ was designated as η₁₀.

Additionally, a Casson plot was obtained by plotting the square root of √σ of the shear stress σ on the vertical axis and the square root of √γ of the shear rate of γ on the horizontal axis. When an approximate straight line is obtained in this plot, the intersection of the approximate straight line with the vertical axis in the region where the shear rate is 10 s⁻¹ or higher represents the square root of √σ₀ of the Casson yield stress, and the slope of the line represents the square root of √η_{∞} of the Casson viscosity.

### <Alcohol Solvent>

The organic solvent used in the copper paste according to this embodiment is a combination of monohydric or dihydric alcohols with different viscosities and dihydric or trihydric alcohols. If polyhydric alcohols with a valence of 4 or more are used as solvents, during sintering, particularly at low temperatures of around 300° C. or lower under reducing atmospheres or nitrogen atmospheres, the alcohol may remain in the sintered body, potentially lowering electrical conductivity and adhesion strength. On the other hand, if only a monohydric alcohol is used as the solvent, it may easily volatilize during storage or printing of the copper paste, causing the viscosity of the copper paste to change and deteriorating its workability. In the copper paste according to this embodiment, by combining monohydric or dihydric alcohols with different viscosities and dihydric or trihydric alcohols, such issues can be avoided, providing a copper paste with excellent properties and workability, with uniformly dispersed copper powder. Particularly, because it contains a high-viscosity second alcohol, sagging of the paste, which deforms the desired shape, after application is suppressed, and, as described later, the viscosity of the copper paste can be adjusted to an appropriate value even without binder components such as resin. If the copper paste does not contain resin components, there is no need to consider carbon residues from the resin components, allowing sintering in a non-oxidizing atmosphere at relatively low temperatures.

In this specification, the term “alcohol solvent” refers to a mixed solvent primarily composed of alcohol, and it may also include a mixed solvent containing a small amount of organic solvents other than water and alcohols, where the mixed solvent, for example, may contain at least one of ethers, ketones, and esters in an amount of 1 to 20 mass %, 2 to 17 mass %, 3 to 15 mass %, 4 to 12 mass %, or 5 to 10 mass %. Additionally, the alcohol solvent may include solvents such as hydrocarbon solvents and halogenated hydrocarbon solvents; however, nitrogen-containing solvents, such as amines and amides, tend to remain in the dried residue, and therefore, it is preferable that these are either not included or, if included, limited to 5 mass % or less, 4 mass % or less, 3 mass % or less, 2 mass % or less, 1 mass % or less, 0.7 mass % or less, 0.5 mass % or less, 0.2 mass % or less, or 0.1 mass % or less.

The total amount of the first alcohol and the second alcohol is not particularly limited; however, it is preferably 5 mass % or more, 5.5 mass % or more, 6 mass % or more, 6.5 mass % or more, 7 mass % or more, 7.5 mass % or more, or 8 mass % or more, relative to the total amount of the copper paste at 100 mass %. On the other hand, the total amount of the first alcohol and the second alcohol is preferably 40 mass % or less, 35 mass % or less, 30 mass % or less, 25 mass % or less, or 20 mass % or less, relative to the total amount of the copper paste at 100 mass %. Ensuring the total amount of the first and second alcohols is above the required level allows the copper paste to be applied uniformly across the entire interface at the desired thickness, resulting in excellent bonding strength. Furthermore, keeping the total amount of the first and second alcohols below the required level prevents the solvent from remaining during sintering, thus suppressing any reduction in electrical conductivity or bonding strength.

The total amount of the first alcohol and the second alcohol is not particularly limited; however, it is preferably 5 mass % or more, 7 mass % or more, 10 mass % or more, 12 mass % or more, 15 mass % or more, 17 mass % or more, 20 mass % or more, 22 mass % or more, 25 mass % or more, 27 mass % or more, or 30 mass % or more, relative to the total amount of copper powder, the first alcohol, and the second alcohol at 100 mass %. Conversely, the total amount of the first alcohol and the second alcohol is preferably 50 mass % or less, 47 mass % or less, 45 mass % or less, 42 mass % or less, 40 mass % or less, 37 mass % or less, 35 mass % or less, 32 mass % or less, 30 mass % or less, 27 mass % or less, or 25 mass % or less, relative to the total amount of copper powder, the first alcohol, and the second alcohol at 100 mass %.

The total amount of the first alcohol and the second alcohol is not particularly limited; however, it is preferably 70 mass % or more, 75 mass % or more, 80 mass % or more, 85 mass % or more, 90 mass % or more, 95 mass % or more, 97 mass % or more, 98 mass % or more, 99 mass % or more, 99.9 mass % or more, or 99.99 mass % or more relative to the total solvent in the copper paste at 100 mass %. Since alcohols, particularly trivalent alcohols, have a reducing effect, increasing their content in the solvent of the copper paste can more effectively suppress oxidation of the copper powder.

The mass ratio (X/Y) of the first alcohol (X) to the second alcohol (Y) in the copper paste is not particularly limited; however, it is preferably 0.2 or more, 0.3 or more, 0.4 or more, or 0.5 or more. Conversely, the ratio (X/Y) of the first alcohol (X) and the second alcohol (Y) is preferably 8 or less, 7 or less, 6 or less, or 5 or less.

To ensure sufficient bonding strength of the copper paste, for example the die shear strength between a chip and a substrate, the copper paste layer must be printed with a nearly uniform thickness at the interface between the chip and the substrate. By maintaining the ratio (X/Y) at or above the required value, the paste achieves a viscosity suitable for application, resulting in superior bonding strength. On the other hand, keeping the ratio (X/Y) at or below the required value ensures that the reducing effect derived from the alcohols is sufficiently manifested, leading to excellent sinterability of the resultant sintered body, achieving high electrical conductivity and bonding strength.

### <First Alcohol>

The first alcohol is at least one alcohol selected from a group consisting of a monohydric alcohol and a dihydric alcohol with viscosities at 25° C. ranging from 3 mPa·s to 70 mPa·s. If the viscosity of the first alcohol falls within this range, it facilitates the application of the copper paste, ensuring ease of use and good workability.

### <Boiling Point of the First Alcohol>

The boiling point of the first alcohol is not particularly limited; however, it is preferably 150° C. or more, 155° C. or more, 160° C. or more, 165° C. or more, 170° C. or more, 175° C. or more, 180° C. or more, 185° C. or more, or 190° C. or more. On the other hand, the boiling point of the first alcohol is preferably 250° C. or less, 245° C. or less, 240° C. or less, 235° C. or less, 230° C. or less, 225° C. or less, 220° C. or less, 215° C. or less, 210° C. or less, 205° C. or less, or 200° C. or less. Having a boiling point of the first alcohol at 150° C. or higher prevents from forming voids in the paste due to a sudden boiling during heating and lowering the sinterability, thereby enhancing the thermal conductivity and bonding strength of the sintered body. In addition, a boiling point of 150° C. or higher ensures that the solvent does not evaporate quickly while storing the copper paste at room temperature, which prevents short-term viscosity changes due to the evaporation of the solvent. Consequently, refrigeration or freezing for storage becomes unnecessary, thus reducing storage costs. Unless otherwise stated, the term “boiling point” in this specification refers to the boiling point under atmospheric pressure.

The boiling point of the first alcohol is not particularly limited; however, it is preferably more than 50° C. lower than the sintering temperature of the copper paste.

The vapor pressure of the first alcohol is not particularly limited; however, it is preferred to have a vapor pressure around room temperature, for example, at 25° C., of 0.1 Pa or more, 0.2 Pa or more, 0.3 Pa or more, 0.4 Pa or more, 0.5 Pa more, 0.6 Pa or more, 0.7 Pa or more, 0.8 Pa or more, 0.9 Pa or more, 1 Pa or more, 1.2 Pa or more, 1.5 Pa or more, 1.7 Pa or more, 2 Pa or more, 2.2 Pa or more, 2.5 Pa or more, 2.7 Pa or more, or 3 Pa or more. On the other hand, the vapor pressure of the first alcohol is not particularly limited; however, it is preferred to have a vapor pressure around room temperature, for example, at 25° C., of 100 Pa or lower, 90 Pa or less, 80 Pa or less, 70 Pa or less, 60 Pa or less, 50 Pa or less, 40 Pa or less, or 30 Pa or less. Having the vapor pressure of the first alcohol within the desired range ensures excellent storage stability and printability.

Examples of the first alcohol include monohydric alcohols such as 1-hexanol (with viscosity of 4.58 mPa·s, boiling point 158° C., and vapor pressure 80 Pa), 1-heptanol (with viscosity of 5.81 mPa·s, boiling point 176° C., and vapor pressure 44 Pa), 2-heptanol (viscosity of 3.96 mPa·s, boiling point 159° C., and vapor pressure 78 Pa), 1-octanol (with viscosity of 7.29 mPa·s, boiling point 195° C., and vapor pressure 24 Pa), 2-octanol (with viscosity of 6.49 mPa·s, boiling point 180° C., and vapor pressure 42 Pa), 2-ethyl-1-hexanol (with viscosity of 6.27 mPa·s, boiling point 185° C., and vapor pressure 35 Pa), benzyl alcohol (with viscosity of 5.47 mPa·s, boiling point 205° C., and vapor pressure 18 Pa) and the dihydric alcohols such as ethylene glycol (with viscosity of 16.1 mPa·s, boiling point 197° C., and vapor pressure 20 Pa), 1,2-propanediol (with viscosity of 40.4 mPa·s, boiling point 188° C., and vapor pressure 28 Pa), 1,3-propanediol (with viscosity of 47 mPa·s, boiling point 214° C., and vapor pressure 5 Pa), 2,3-butanediol (with viscosity of 45 mPa·s, boiling point 182° C., and vapor pressure<100 Pa). Among these, it is preferable to use 1-octanol, 2-octanol, 2-ethyl-1-hexanol, ethylene glycol, or 1,2-propanediol as the first alcohol. As the first alcohol, any of the above-mentioned alcohols that meet the requirements may be used singly or in combination. The viscosity and vapor pressure are both measured at 25° C. As mentioned above, since the first alcohol has low viscosity, it is possible to adjust the viscosity of the copper paste to the appropriate value by adding a smaller amount. Therefore, the total amount of organic solvents in the copper paste can be reduced, and the remaining organic solvent content during firing can be suppressed.

### <Second Alcohol>

The second alcohol is at least one alcohol selected from a group consisting of divalent alcohols and trivalent alcohols that have a viscosity of 300 mPa·s or more and 1000 mPa·s or less at 25° C. If the viscosity of the second alcohol is within this range, it can prevent the copper paste from slumping and losing its desired shape before sintering, and also ensures that the workability of the copper paste is not impaired.

The boiling point of the second alcohol is not particularly limited; however, it is preferable to be 150° C. or more, 160° C. or more, 170° C. or more, 180° C. or more, 190° C. or more, 195° C. or more, 200° C. or more, 205° C. or more, 210° C. or more, 215° C. or more, 220° C. or more, 225° C. or more, 230° C. or more, 235° C. or more, 240° C. or more, 245° C. or more, 250° C. or more, 255° C. or more, 260° C. or more, 265° C. or more, 270° C. or more, 275° C. or more, 280° C. or more, or 285° C. or more. On the other hand, the boiling point of the second alcohol is preferably 320° C. or lower, 315° C. or lower, 310° C. or lower, 305° C. or lower, 300° C. or lower, or 295° C. or lower. By having the boiling point of the second alcohol within this range, it ensures that the alcohol will not remain in the gaps between copper particles in the sintered body after low-temperature sintering, preventing a reduction in thermal conductivity. Furthermore, by having the boiling point of the second alcohol meet the required value or higher, it prevents from reducing the sinterability due to occurrence of voids in the paste because of the sudden boiling and increases the thermal conductivity and bonding strength of the sintered body. Additionally, if the boiling point of the second alcohol meets the required value or higher, the copper paste can be stored at room temperature without the solvent evaporating and causing a rapid viscosity change, which eliminates the need for refrigeration or freezing, thus reducing storage costs.

The boiling point of the second alcohol is not particularly limited; however, it is preferable to be 50° C. lower than the sintering temperature of the copper paste.

It is preferable to use a second alcohol with a higher boiling point than the first alcohol. The inclusion of a low-viscosity first alcohol makes the copper paste according to the present embodiment have an appropriate viscosity and excellent workability; however, after applying the paste, there is no need to adjust the viscosity, and from the perspective of preventing the paste from spreading, it is preferable that the first alcohol is eliminated. On the other hand, among the alcohols, divalent alcohols, trivalent alcohols, and especially trivalent alcohols, have strong reducing properties, so the second alcohol containing at least one of these is preferably present at a high concentration during sintering. Therefore, by using a second alcohol with a higher boiling point than the first alcohol, one that evaporates near the sintering temperature of the copper paste, it is possible to maintain good workability and more effectively suppress oxidation of the copper powder.

Moreover, when the vapor pressure at around room temperature, for example, at 25° C., is 1 mPa or more and 5 Pa or less, and more preferably 1.5 Pa or less, especially 1 Pa or less, the storage stability improves and the oxidation suppression effect during sintering is further enhanced, making it preferable. This effect becomes particularly prominent when the vapor pressure of the second alcohol is lower compared to that of the first alcohol.

The vapor pressure of the second alcohol is not particularly limited; however, it is preferable that the vapor pressure at around room temperature, for example at 25° C., be 1 mPa or more, 2 mPa or more, 3 mPa or more, 4 mPa or more, 5 mPa or more, 6 mPa or more, 7 mPa or more, 8 mPa or more, 9 mPa or more, or 10 mPa or more. On the other hand, the vapor pressure of the second alcohol is not particularly limited; however, it is preferable that the vapor pressure be 100 Pa or less, 90 Pa or less, 80 Pa or less, 70 Pa or less, 60 Pa or less, 50 Pa or less, 40 Pa or less, and 30 Pa or less. By ensuring that the vapor pressure of the first alcohol falls within the required range, both storage stability and printability are enhanced.

Specifically, as the second alcohol, one can use a divalent alcohol such as 2-ethyl-1,3-hexanediol (with viscosity of 323 mPa·s, boiling point 244° C., and vapor pressure<1.4 Pa) and a trivalent alcohol such as glycerol (with viscosity of 934 mPa·s, boiling point 290° C., and vapor pressure 0.01 Pa). The second alcohol may be used either singly, provided it meets the requirements of the second alcohol described above, or as a mixture of two or more types.

### <Copper Powder>

The copper powder is contained within the copper paste, and by sintering such a paste, it forms the sintered body.

Copper powder is not particularly limited and can be any commercially available product. For copper powder, methods such as the high-pressure water atomization method described in International Publication WO99/11407, or the wet reduction precipitation method described in WO2014/80662, can be used for its production. The high-pressure water atomization method is a process for producing metal powders such as copper from molten metal, where a molten metal is split by the gas near the nozzle outlet as the molten metal stream flows downward through the center of the nozzle, where the gas flows, and subsequently, the molten metal, which has been split, is further fragmented by a liquid ejected in an inverted conical shape. According to this method, allowing the continuous fragmentation of the molten metal by both gas and liquid results in particles with fine diameters in a spherical or granular shape, and the large-scale, low cost production of metal powders such as copper with a low oxygen content can be achieved industrially. On the other hand, the wet reduction precipitation method is a technique for reducing copper ions using a reducing agent like hydrazine in a wet process, where an organic solvent that is miscible with water and reduces the surface tension of water is used. Specifically, in this method, using water and the organic solvent as the liquid medium, and the reaction solution containing monovalent copper ions and divalent copper ions and the reducing agent are mixed to reduce the copper ions to generate the copper particles. Generally, the high-pressure water atomization method can produce particles with a size of 0.7 μm or larger. The wet reduction precipitation method is more suitable for producing particles with finer dimensions.

In one embodiment, the average particle diameter of copper powder (copper particles) is not particularly limited; however, it is preferably, for example, 0.05 μm or more, 0.06 μm or more, 0.07 μm or more, 0.08 μm or more, 0.09 μm or more, 0.1 μm or more, 0.12 μm or more, 0.15 μm or more, 0.17 μm or more, 0.2 μm or more, 0.22 μm or more, 0.25 μm or more, 0.27 μm or more, or 0.3 μm or more. On the other hand, the average particle diameter of copper powder is preferably 2.0 μm or less, 1.9 μm or less, 1.8 μm or less, 1.7 μm or less, 1.6 μm or less, 1.5 μm or less, 1.4 μm or less, 1.3 μm or less, 1.2 μm or less, 1.1 μm or less, 1 μm or less, 0.9 μm or less, 0.8 μm or less, or 0.7 μm or less. When the average particle diameter of the copper powder is below the required value, the surface area of the copper powder increases relatively, making it easier to sinter at low temperatures. On the other hand, when the average particle diameter of the copper powder is above the required value, the increase in the price of the copper powder can be suppressed. Furthermore, when the average particle diameter is above the required value, it is possible to prevent the formation of defects in the sintered body due to the aggregation of numerous particles. In this specification, “average particle diameter” refers to the 50% particle diameter (D50), which is the median of the particle size distribution measured using a laser particle size analyzer or the like.

In one embodiment, the copper powder preferably includes the first copper particles with an average particle diameter of 50 nm or more and 900 nm or less, the second copper particles with an average particle diameter of 150 nm or more and 1 μm or less, which is 100 nm or more larger than the average particle diameter of the second copper particle of the first copper particles, and the third copper particles, which are plate-like, scale-like, flat-like, or flaky in shape, with an average particle diameter of 1.5 μm or more and 20 μm or less. As there is a difference in average particle diameter of 100 nm or more between the first copper particles and the second copper particles, the first copper particles, which have smaller average diameter than that of the second copper particles, can fill gaps between the second copper particles, which have larger average diameter than that of the first copper particles, resulting in a dense sintered body. Furthermore, by containing the third copper particles in a flaky shape or the like, it is possible to suppress the occurrence of cracks after applying and drying the paste.

The shape of the first copper particles is not particularly limited; however, examples of preferable shapes of the first copper particle includes a spherical shape, an elliptical shape, a polyhedral shape, an irregular shape, a wire-like shape, and a dendritic shape.

The average particle diameter of the first copper particles is preferably, for example, 60 nm or more, 70 nm or more, 80 nm or more, 90 nm or more, 100 nm or more, 120 nm or more, 150 nm or more, 170 nm or more, 200 nm or more, 220 nm or more, or 250 nm or more. On the other hand, the average particle diameter of the first copper particles is preferably 850 nm or less, 800 nm or less, 750 nm or less, 700 nm or less, 650 nm or less, 600 nm or less, 550 nm or less, 500 nm or less, 450 nm or less, 400 nm or less, 350 nm or less, or 300 nm or less.

The content of the first copper particles is not particularly limited; however, it is preferably, for example, 20 mass % or more, 25 mass % or more, 30 mass % or more, 35 mass % or more, 40 mass % or more, 45 mass % or more, 50 mass % or more, 55 mass % or more, 60 mass % or more, 65 mass % or more, or 70 mass % or more, based on 100 mass % of copper powder. On the other hand, the content of the first copper particles in the copper powder is preferably 90 mass % or less, 85 mass % or less, or 80 mass % or less, based on 100 mass % of copper powder.

The shape of the second copper particles is not particularly limited; however, it is preferable that they have shapes such as spherical, elliptical, polyhedral, irregular, wire-like, or dendritic.

The average particle diameter of the second copper particles is preferably, for example, 160 nm or more, 170 nm or more, 180 nm or more, 190 nm or more, 200 nm or more, 220 nm or more, 250 nm or more, 270 nm or more, 300 nm or more, 320 nm or more, or 350 nm or more. On the other hand, the average particle diameter of the second copper particles is preferably 950 nm or less, 900 nm or less, 850 nm or less, 800 nm or less, 750 nm or less, 700 nm or less, 650 nm or less, 600 nm or less, 550 nm or less, 500 nm or less, 450 nm or less, or 400 nm or less.

The average particle diameter of the second copper particles is preferably 100 nm larger than that of the first copper particles. On the other hand, the average particle diameter of the second copper particles is preferably 900 nm or less, 800 nm or less, 700 nm or less, 600 nm or less, 500 nm or less, 400 nm or less, 300 nm or less, or 200 nm or less than that of the first copper particles.

The content of the second copper particles is not particularly limited; however, it is preferably, for example, 1 mass % or more, 2 mass % or more, 3 mass % or more, 4 mass % or more, 5 mass % or more, 6 mass % or more, 7 mass % or more, 8 mass % or more, 9 mass % or more, 10 mass % or more, 11 mass % or more, or 12 mass % or more, based on 100 mass % of copper powder. On the other hand, the content of the second copper particles in the copper powder is preferably 30 mass % or less, 27 mass % or less, 25 mass % or less, 22 mass % or less, 20 mass % or less, or 18 mass % or less, based on 100 mass % of copper powder.

The average particle diameter of the third copper particles is preferably, for example, 1.5 μm or more, 2 μm or more, 2.5 μm or more, 3 μm or more, 3.5 μm or more, 4 μm or more, 4.5 μm or more, 5 μm or more, 5.5 μm or more, or 6 μm or more. On the other hand, the average particle diameter of the third copper particles is preferably 20 μm or less, 19 μm or less, 18 μm or less, 17 μm or less, 16 μm or less, 15 μm or less, 14 μm or less, 13 μm or less, 12 μm or less, 11 μm or less, 10 μm or less, 9 μm or less, or 8 μm or less.

The content of the third copper particles in the copper powder is not particularly limited; however, it is preferably, for example, 5 mass % or more, 5.5 mass % or more, 6 mass % or more, 6.5 mass % or more, 7 mass % or more, 7.5 mass % or more, 8 mass % or more, 8.5 mass % or more, 9 mass % or more, or 9.5 mass % or more, based on 100 mass % of copper powder. On the other hand, the content of the third copper particles in the copper powder is preferably 60 mass % or less, 55 mass % or less, 50 mass % or less, 45 mass % or less, 40 mass % or less, 35 mass % or less, 30 mass % or less, 25 mass % or less, 20 mass % or less, 15 mass % or less, or 12 mass % or less, based on 100 mass % of copper powder.

The copper powder (copper particles) may have a portion of its surface coated with an organic material. As organic materials, compounds of either polysaccharides or fatty acid are preferred. Polysaccharide molecules make the outer side (the side in contact with the solvent) hydrophilic when coating the copper powder, which interacts with the hydroxyl groups of the organic solvent in the copper paste to provide an appropriate viscosity. On the other hand, fatty acids have their carboxyl groups bound to the copper particle surface, while the opposite end of the fatty acid becomes hydrophobic, improving the dispersion of the copper particles and suppressing particle agglomeration. As a result of these actions of the polysaccharides and fatty acids, the copper paste can form a uniform layer with consistent thickness, ensuring excellent bonding strength across the entire interface.

Specific examples of polysaccharides include gum arabic, carboxymethyl cellulose, hydroxyethyl cellulose, cellulose nanofibers, starch, glycogen, agarose (agar), pectin, and alginic acid, as well as their salts; however, the selection is not limited to these, and sulfur-containing polysaccharides, such as carrageenan, can also be used. Among the examples, it is preferable to use one or more selected from gum arabic and sodium alginate.

Specific examples of fatty acids include medium-chain fatty acids such as pentanoic acid, octanoic acid, nonanoic acid, decanoic acid, dodecanoic acid, and tetradecanoic acid. Among these, it is preferable to use one or more selected from octanoic acid, nonanoic acid, decanoic acid, dodecanoic acid, and tetradecanoic acid.

The surface coverage of the organic material is not particularly limited; however, it is preferable that, with respect to copper powder with a coating layer accounting for 100 mass %, the carbon content is 0.05 mass % or more and 0.8 mass % or less, and more preferably 0.1 mass % or more and 0.5 mass % or less, and the oxygen content is preferably 0.05 mass % or more and 1.5 mass % or less, and more preferably 0.1 mass % or more and 1 mass % or less.

By ensuring that the carbon and oxygen contents are above the required levels, the hydrophilicity of the polysaccharide molecules on the copper powder surface can be sufficiently manifested, which reduces the viscosity of the copper paste and forms a uniform paste layer, thereby improving the bonding strength of the resulting sintered body. On the other hand, by keeping the carbon and oxygen contents below the required levels, for example it is possible to prevent carbon-oxygen containing components from remaining inside the sintered body during sintering in a nitrogen atmosphere, thereby enhancing the thermal conductivity and bonding strength of the sintered body.

When using the three types of copper particles described above that are the first copper particles, the second copper particles, and the third copper particles as copper powder, it is preferable that at least one of the first and second copper particles has at least a portion of its surface coated with an organic material. The organic material may be polysaccharides or fatty acids, with polysaccharides being preferred. Additionally, the third copper particles may also have at least a portion of their surface coated with an organic material (such as polysaccharides, fatty acids, etc.).

In the copper paste according to the present embodiment, the total content of elements other than copper in the copper powder is not particularly limited; however, it is preferably, for example, 1 mass % or less, 0.5 mass % or less, or 0.1 mass % or less, based on 100 mass % of the copper powder. Among the components other than copper, especially metal elements, some may deteriorate the sinterability by segregating on the surface of the copper powder or forming oxides, and could dissolve within the copper powder, potentially reducing the electrical conductivity of the sintered body. If the total content of metal elements such as As, Co, Cr, Fe, Ir, P, S, Sb, Se, Te, Ti, V, and Zr is below the required amount, the electrical resistivity of the copper paste sintered body can be further reduced, and it will show better thermal conductivity. With such thermal conductivity, it becomes possible to efficiently dissipate heat generated from power modules to the outside.

### <Other Components>

Other than the above-described substances, the copper paste according to the present embodiment may contain dispersants and surfactants made of amines, antioxidants, reducing agents such as hydrazine, glass frits, and binders including resin components.

As resin components, there is no particular limitation; however, one or more resins can be selected from cellulose-based resins such as methyl cellulose, ethyl cellulose, and carboxymethyl cellulose, acrylic resins, butyral resins, alkyd resins, epoxy resins, and phenolic resins.

The content of resin components is not particularly limited; however, based on 100 mass % of the copper powder, it is preferably more than 0 mass %, 0.01 mass % or more, 0.05 mass % or more, and 0.1 mass % or more. The resin component content, based on the mass of the copper particles (100 mass %), may be, for example, 10 mass % or less, 9 mass % or less, 8 mass % or less, 7 mass % or less, 6 mass % or less, 5 mass % or less, 4 mass % or less, 3 mass % or less, 2 mass % or less, 1 mass % or less, 0.5 mass % or less, 0.1 mass % or less, 0.05 mass % or less, 0.01 mass % or less; however, it is preferable that the copper paste does not contain resin components. If the copper paste contains resin components, the sinterability (especially below 350° C.) may deteriorate. For example, thermosetting resins such as epoxy resins remain in the copper paste sintered body even after sintering. When using cellulose resins, although decomposition starts around 300° C., heating above 400° C. is required to fully decompose, and sintering in an oxygen atmosphere is necessary to remove the carbon residue generated during the decomposition, which could cause oxidation of the copper powder. In contrast, a copper paste without resin components can be sintered at relatively low temperatures in a non-oxidizing atmosphere, leading to the formation of a sintered high-density copper body without the risk of conductivity degradation due to oxidation of the copper powder. Since the copper paste according to this embodiment contains a high-viscosity second alcohol, the viscosity can be appropriately adjusted to the desired value even without the inclusion of resin components.

Furthermore, the copper paste preferably does not contain either an epoxy group-containing silane coupling agent or an amino group-containing silane coupling agent, or it may contain both an epoxy group-containing silane coupling agent and an amino group-containing silane coupling agent, in a total amount of more than 0 mass % but not exceeding 0.05 mass % based on 100 mass % of the copper powder.

### <Applications of the Copper Paste>

The copper paste according to the present embodiment, as described above, has high electrical conductivity and thermal conductivity, and exhibits excellent storage stability and workability. In addition, the copper paste of the present embodiment can be sintered at low temperatures and in a short time, and can exhibit high die shear strength. Therefore, the copper paste can be used for the formation of wiring in electronic components such as power modules, chip resistors, chip capacitors, and solar cells, and for electronic assemblies such as substrates with through-holes formed thereon. For example, by applying the copper paste according to the present embodiment to such as substrates for mounting such as power modules, solar cell, and electronic assemblies, printed circuit boards, and substrates with through-holes, and sintering the same to form the sintered copper body. Here, the substrate materials that can be used include, but are not limited to: silicon substrates; oxide substrates, such as silicate glass, alumina, and quartz; nitride substrates, such as silicon nitride and aluminium nitride; carbide substrates, such as silicon carbide and titanium carbide; resin-based substrates, such as polyimide, polyethylene terephthalate, and polyethylene naphthalate; and substrates with transparent conductive films (TCO) or metal films on the surface.

### <Production of the Copper Paste>

The copper paste according to the present embodiment can be produced by mixing the copper powder described above with a solvent, and if necessary, kneading the mixture using a device such as a planetary mixer. Additionally, if necessary, the dispersion of the copper powder can be enhanced by using a three-roll mill. Furthermore, the paste can be subjected to filtration or defoaming treatment as needed.

### <Sintering the Copper Paste>

When sintering the copper paste according to the present embodiment, the method and conditions are not particularly limited, and can be performed using any method depending on the target product and the substrate on which the paste is applied. However, it is preferable to first dry and remove the first alcohol before sintering the copper paste. Removing the first alcohol before sintering the copper paste increases the proportion of the second alcohol around the copper powder, which helps to more effectively prevent the oxidation of the copper powder during the sintering process. The drying conditions are not particularly restricted and can be set based on the boiling point of the first alcohol and the target product; however, for example, it is preferable to heat in an atmospheric environment at 50-200° C., particularly 60-150° C., for 1 to 60 minutes. Drying can also be carried out under reduced pressure, allowing for lower heating temperatures. Additionally, the drying process can be performed under an inert gas atmosphere or reducing atmosphere.

The copper paste according to the present embodiment allows for sintering at low temperatures and in a short time, so the sintering conditions are not particularly limited. For example, sintering can be carried out in an inert gas atmosphere such as nitrogen and argon, or in a reducing atmosphere containing 0.1 to 30 volume % of hydrogen, ammonia, carbon monoxide, and alcohol vapor at temperatures ranging from 150° C. to 400° C. or 200° C. to 300° C., particularly temperatures ranging at 250° C. to 300° C., for 10 seconds to 60 minutes, more preferably for 2 minutes to 30 minutes, resulting in sintered bodies that exhibit excellent electrical conductivity, thermal conductivity, and die shear strength.

### EXAMPLE(S)

The following provides a more detailed explanation of the present invention through examples; however, the invention is not limited to these examples.

### [Physical Properties of the Samples-Performance Evaluation]

The paste prepared under the compositions and conditions described below was evaluated for its physical properties and performance according to the evaluation methods outlined in the following sections.

### <Viscosity Measurement and Measurement of Casson Yield Stress and Casson Viscosity>

The viscosity of the prepared paste was measured using a dynamic viscoelasticity measurement device (RST Cone Plate Rheometer by Brookfield) equipped with a cone-plate spindle, and the viscosity of the copper paste at a shear rate of 10 s⁻¹ was denoted as η₁₀. Additionally, a Casson plot, where the square root of √σ₀ of the shear stress σ is plotted on the vertical axis and the square root of √γ of the shear rate of γ is plotted on the horizontal axis, was obtained. In this plot, when an approximate straight line is obtained, a Casson plot becomes possible, and the intercept of the vertical axis of the approximate straight line in the region where the shear rate is 10 s⁻¹ or higher represents the square root of √σ₀ of the Casson yield stress, while the slope of the approximate straight line represents the square root of √η_{∞} of the Casson viscosity. Here, obtaining the approximate straight line means that the R² value (coefficient of determination) is 0.9 or higher.

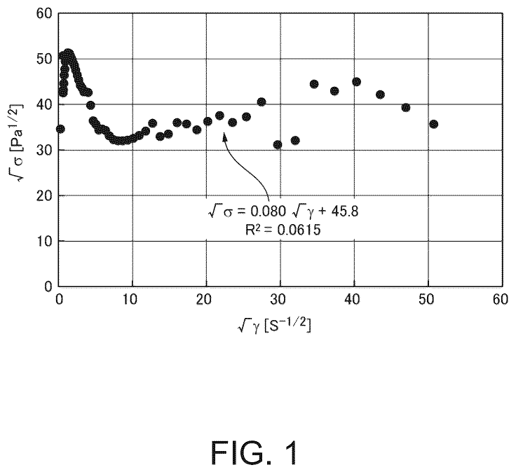

The following describes specific examples of the present invention. As a representative result, Casson plots were created for three types of copper pastes including Comparative Example 2, Comparative Example 1, and Example 4, details of which are provided later. FIG. 1 shows the Casson plot of the paste in Comparative Example 2 (η₁₀₌₁₈₅ Pa·s). In the region where the shear rate is 10 s⁻¹ or higher, the R² value was 0.0615. As clearly seen in FIG. 1, the plot does not exhibit linearity, making it impossible for fitting using the Casson equation.

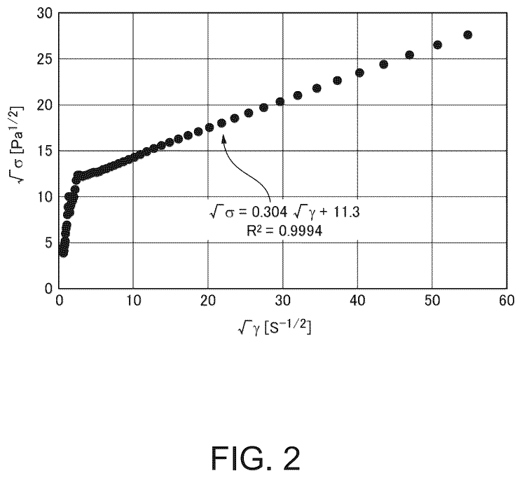

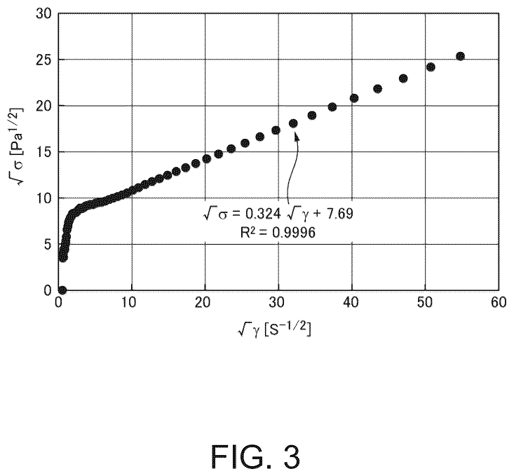

On the other hand, FIG. 2 shows the Casson plot of the paste in Comparative Example 1 (η₁₀₌₁₁ Pa·s), and FIG. 3 shows the Casson plot of the paste in Example 4 (η₁₀=8 Pa·s). In the Casson plots shown in FIG. 2 and FIG. 3, the R² values in the region where the shear rate is 10 s⁻¹ or higher are 0.9994 and 0.9996, respectively, indicating that linear approximation of the data is possible. In both cases, a sharp increase of √σ can be seen in the low shear rate region and a gradual increase of √σ can be seen in high shear rate region. Since the sharp increase corresponds to the phenomenon of breaking up agglomerates of fine particles contained in the paste, reflecting the characteristics of a homogeneous paste, the intercept √σ₀ and slope √η_{∞} are obtained from the approximate straight line in the high shear rate region of 10 s⁻¹ or higher.

### <Observation of Structural Defects>

The prepared paste was stencil printed onto a glass substrate using a metal mask to form a square with a side length of 20 mm and was then dried in the atmosphere at 100° C. for 5 minutes. The surface structure of the dried paste was observed using a stereomicroscope with 10× magnification to check for any structural defects such as holes, protrusions, and cracks.

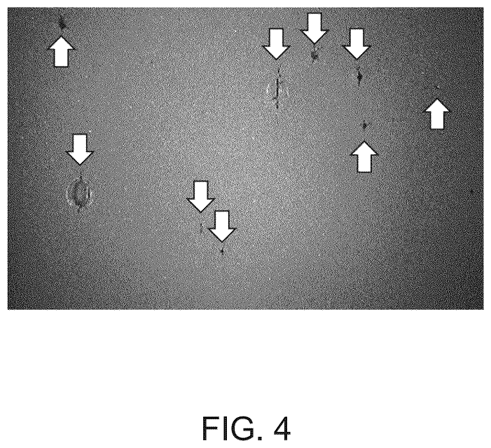

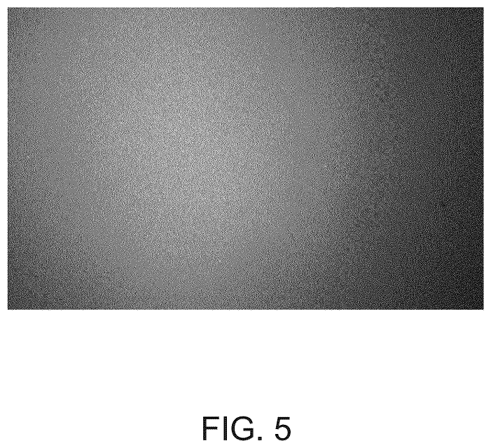

Explanations are provided below with specific examples. The following shows the results of surface observations of the dried materials obtained by printing the pastes of Comparative Example 1 and Example 4, where linear approximation was possible in the Casson plot, onto a glass substrate and drying them. FIG. 4 shows an optical microscope image of the dried material of the paste from Comparative Example 1. FIG. 5 shows an optical microscope image of the dried material of the paste from Example 4. In the dried material of the paste from Comparative Example 1, numerous holes were observed, which are indicated by arrows in FIG. 4. In contrast, no holes or other structural defects were observed in the dried material of the paste from Example 4. Similar tests were conducted on pastes prepared under various process conditions to confirm the presence or absence of surface defects and printing deficiencies.

### <Measurement of Electrical Resistivity>

The prepared paste was applied onto a glass substrate by stencil printing using a metal mask to form a square with 20 mm side and then dried in the air at 100° C. for 5 minutes. Subsequently, pressure sintering was performed in a nitrogen atmosphere using a high-temperature press machine to sinter by applying a load of 20 MPa at the heating temperature of 280° C. for 2 minutes, resulting in a sintered copper paste body with a thickness of approximately 20 μm. The electrical resistivity of the sintered body was measured using a direct current four-point probe method, with a probe spacing of 1 mm. According to the Wiedemann-Franz law, the electrical resistivity was converted into thermal conductivity, which corresponded to a value of 134 Wm⁻¹ K⁻¹ or higher.

### <Measurement of Die Shear Strength>

A copper plate with a thickness of 1 mm was used as the substrate, and a copper paste was applied to achieve a thickness of 100 μm. A semiconductor chip made of silicon carbide (SiC) with dimensions of 2 mm×2 mm×0.4 mm was then placed on top of the paste. A Ti layer with a thickness of 500 nm and a Cu layer with a thickness of 500 nm were deposited on the surface of the copper paste contacting the SiC chip using the sputtering method. The obtained laminate was subjected to a press-sintering process by applying a load of 20 MPa in a nitrogen atmosphere using a high-temperature press machine and sintering at the sintering temperature of 280° C. for 3 minutes. The sample obtained through the press-sintering process was cooled to room temperature, and an adhesion strength between the SiC chip and the copper substrate was measured as the die shear strength using a die shear tester (NAGE4000 by Nordson).

### <Evaluation Criteria>

With respect to the measurement, the evaluation was classified as “AA” if all of the following four conditions were satisfied: (1) the dried paste has no surface defects; (2) the dried paste has no printing defects; (3) the electrical resistivity of the sintered body is 5 μΩcm or less; and (4) the die shear strength of the sintered body is 30 MPa or more. Further evaluation classified as “A” if three of the conditions were satisfied, “B” if two of the conditions were satisfied, and “C” if 1 of the condition was satisfied.

### Test 1: Effect of Paste Viscosity and Casson Yield Stress

### Example 1

For the copper particles, Example 1 used a first copper particle with a D50 of 270 nm and a roughly spherical shape, a second copper particle with a D50 of 380 nm and a roughly spherical shape, and a third copper particle with a D50 of 7 μm and a flaky shape. The two types of copper particles as described above, with the exception of the flaky shape, were coated with gum arabic having a polysaccharide surface.

First, the first copper particle, second copper particle, and third copper particle were mixed in a mass ratio of 65:30:5. The impurity content in the first to third copper particles was as follows: carbon of 0.3%, oxygen of 0.7%, and copper-free metal elements of 0.2%. Ethylene glycol was used as the first alcohol and glycerol as the second alcohol, and the copper particles, ethylene glycol, and glycerol were weighed in a mass ratio of 60:20:20 to be mixed using a planetary mixer in order to prepare the copper paste. The evaluation results are shown in Table 1.

### Examples 2-7 and Comparative Examples 1-4

Except for the changes in the mass ratio of copper powder to solvent and the mass ratio of the first to third copper particles, the copper paste was prepared under the same conditions as in Example 1. The evaluation results are shown in Table 1. In Table 1, “N/A” indicates that a good approximation line (fitting) could not be obtained in the Casson plot.

TABLE 1

| | Copper | Copper particles | | | | | | Electrical | Die shear | |
|---|---|---|---|---|---|---|---|---|---|---|
| | powder:Solvent | First:Second:Third | η₁₀ | √σ₀ | √η_{∞} | Surface | Printing | resistivity | strength | |
| | (Mass Ratio) | (Mass ratio) | [Pa · s] | [Pa^{-1/2}] | [Pa · s^{1/2}] | defects | defects | [μΩcm] | [Mpa] | Evaluation |
| Example 1 | 60:40 | 65:30:5 | 49 | 9.8 | 0.57 | None | None | 4.2 | 43 | AA |
| Example 2 | 95:5 | 60:30:10 | 29 | 9.1 | 0.32 | None | None | 3.6 | 62 | AA |
| Example 3 | 75:25 | 50:20:30 | 11 | 8.7 | 0.3 | None | None | 3.2 | 89 | AA |
| Example 4 | 70:30 | 35:15:50 | 8.0 | 7.7 | 0.32 | None | None | 3.5 | 58 | AA |
| Example 5 | 60:40 | 39:1:60 | 3.0 | 6.8 | 0.31 | None | None | 4.8 | 42 | AA |
| Example 6 | 65:35 | 50:20:30 | 7.0 | 8.0 | 1.2 | None | None | 5.3 | 30 | A |
| Example 7 | 55:45 | 50:20:30 | 1.0 | 1.0 | 1.1 | None | None | 6.0 | 34 | A |
| Comparative Example 1 | 80:20 | 65:20:15 | 11 | 11.3 | 0.3 | Yes | None | 5.2 | 31 | B |
| Comparative Example 2 | 96:4 | 70:28:2 | 185 | N/A | N/A | Yes | Yes | 6.1 | 15 | C |
| Comparative Example 3 | 85:15 | 70:10:20 | 73 | N/A | N/A | None | Yes | 5.9 | 23 | C |
| Comparative Example 4 | 80:20 | 70:10:20 | 47 | 16 | 0.3 | Yes | None | 5.1 | 29 | C |

It was found that the values of η₁₀, √σ₀, and √η_{∞} can be controlled by adjusting a paste composition by using a first alcohol (ethylene glycol) with a viscosity range of 3 mPa·s or more to 70 mPa·s or less and a second alcohol (glycerol) with a viscosity range of 300 mPa·s or more to 1000 mPa·s or less as the solvents. Additionally, by adjusting η₁₀ and √σ₀, it was found that a paste with favorable evaluation results can be obtained.

### Test 2: Effect of the First Alcohol Type

### Examples 8-13 and Comparative Examples 5-7

Except for changing the first alcohol (ethylene glycol) to the alcohols shown in Table 2, the paste was prepared and evaluated in the same manner as in Example 3. The evaluation results are shown in Table 2.

TABLE 2

| | First alcohol | | | | | | | | | | |
|---|---|---|---|---|---|---|---|---|---|---|---|
| | | | Boiling | | | | | | Electrical | Die shear | |
| | | Viscosity | point | η₁₀ | √σ₀ | √η_{∞} | Surface | Printing | resistivity | strength | |
| | Type | [mPa · s] | [° C.] | [Pa · s] | [Pa^{-1/2}] | [Pa · s^{1/2}] | defects | defects | (μΩcm) | (MPa) | Evaluation |
| Example 3 | Ethylene glycol | 16 | 197 | 11 | 8.7 | 0.3 | None | None | 3.2 | 89 | AA |
| Example 4 | Diethylene glycol | 30 | 245 | 13 | 8.7 | 0.32 | None | None | 4.1 | 54 | AA |
| Example 5 | Hexylene glycol | 34 | 197 | 13 | 9.6 | 0.41 | None | None | 3.8 | 53 | AA |
| Example 6 | 1,2-Propylene glycol | 36 | 188 | 15 | 9.8 | 0.43 | None | None | 3.8 | 67 | AA |
| Example 7 | 1,3-Propylene glycol | 47 | 214 | 14 | 8.6 | 0.33 | None | None | 4.3 | 71 | AA |
| Example 8 | Triethylene glycol | 49 | 285 | 15 | 8.9 | 0.38 | None | None | 4.8 | 54 | AA |
| Example 9 | 2,3-Butanediol | 45 | 182 | 18 | 9.1 | 0.48 | None | None | 5.8 | 41 | A |
| Comparative | Ethanol | 1.1 | 78 | 2 | 0.5 | 0.1 | Yes | None | 7.1 | 38 | B |
| Example 5 | | | | | | | | | | | |
| Comparative | 2-Propanol | 2.1 | 82 | 1.5 | 0.2 | 0.12 | Yes | None | 6.9 | 34 | B |
| Example 6 | | | | | | | | | | | |
| Comparative | 1,4- Butanediol | 71 | 235 | 52 | 12 | 0.94 | Yes | Yes | 6.1 | 28 | C |
| Example 7 | | | | | | | | | | | |

From Table 2, it can be seen that the first alcohol is not limited to ethylene glycol, and as long as the copper paste uses a monohydric or dihydric alcohol with a viscosity within the required range, a sintered body with the desired performance can be obtained.

### Test 3

### Effect of the Second Alcohol Type

### Example 14 and Comparative Examples 8-9

Except for changing the second alcohol from glycerol to the alcohols shown in Table 3, the paste was prepared in the same manner as Example 3 and evaluated. The evaluation results are shown in Table 3.

TABLE 3

| | Second alcohol | | | | | | | | | | |
|---|---|---|---|---|---|---|---|---|---|---|---|
| | | | Boiling | | | | | | Electrical | Die shear | |
| | | Viscosity | Point | η₁₀ | √σ₀ | √η_{∞} | Surface | Printing | resistivity | strength | |
| | Type | [mPa · s] | [° C.] | [Pa · s] | [Pa^{-1/2}] | [Pa · s^{1/2}] | defects | defects | (μΩcm) | (MPa) | Evaluation |
| Example 3 | Glycerol | 934 | 290 | 11 | 8.7 | 0.3 | None | None | 3.2 | 89 | AA |
| Example 14 | 2-Ethyl-1,3-hexanediol | 323 | 244 | 13 | 8.7 | 0.32 | None | None | 4.7 | 56 | AA |
| Comparative | 1,3-Propylene glycol | 47 | 214 | 13 | 9.6 | 0.41 | Yes | None | 5.9 | 24 | C |
| Example 8 | | | | | | | | | | | |
| Comparative | Triethylene glycol | 49 | 285 | 15 | 9.8 | 0.43 | Yes | None | 5.8 | 28 | C |
| Example 9 | | | | | | | | | | | |

From Table 3, it was found that the second alcohol is not limited to ethylene glycol, and as long as a copper paste is used with a divalent or trivalent alcohol within the required viscosity range, a sintered body with the desired performance can be obtained.

1: A copper paste comprising copper powder and an alcohol solvent, wherein
the alcohol solvent contains:
a first alcohol composed of at least one type of alcohol selected from the group comprising monohydric alcohols and dihydric alcohols, which has a viscosity of 3 mPa·s or more and 70 mPa·s or less at 25° C.; and
a second alcohol composed of at least one type of dihydric alcohols and trihydric alcohols, which has a viscosity of 300 mPa·s or more and 1000 mPa·s or less at 25° C., and wherein
the viscosity of η₁₀ at a shear rate of 10 s⁻¹ at 25° C. is 1 Pa·s or more and 50 Pa·s or less, and the square root of √σ₀ of the Casson yield stress of σ₀ is 10 Pa^{1/2} or less.

2: The copper paste according to claim 1, wherein the square root of √η_{∞} of the Casson viscosity of η_{∞} is 1 Pa·s^{1/2} or less.

3: The copper paste according to claim 1, wherein the copper powder further comprises:
first copper particles which have an average particle diameter of 50 nm or more and 900 nm or less,
second copper particles which have an average particle diameter of 150 nm or more and 1 μm or less, which are at least 100 nm larger than the average particle diameter of the first copper particles, and
third copper particles that are in a plate-shape, a scaly shape, a flat-shape, or a flaky shape and have an average particle diameter of 1.5 μm or more and 20 μm or less.

4: The copper paste according to claim 3, wherein
the copper powder contains, relative to 100 mass % of the copper powder,
1 mass % or more and 30 mass % or less of the second copper particles, and
5 mass % or more and 60 mass % or less of the third copper particles.

5: The copper paste according to claim 1, wherein
the total amount of the first alcohol and the second alcohol is 5 mass % or more and 50 mass % or less, relative to the total mass of the copper powder, the first alcohol, and the second alcohol, which is 100 mass %.

6: The copper paste according to claim 1, wherein
the paste contains no resin or contains resin in an amount of more than 0 mass % and 10 mass % or less, relative to 100 mass % of the copper powder.

7: The copper paste according to claim 1, which does not contain a silane coupling agent that has an epoxy group and a silane coupling agent that has an amino group, or contains the silane coupling agent that has the epoxy group and the silane coupling agent that has the amino group in an amount of more than 0 mass % and 0.05 mass % or less, relative to 100 mass % of the copper powder.

8: The copper paste according to claim 1, wherein
the first alcohol contains one or more alcohols selected from the group comprising 1-hexanol, 1-heptanol, 2-heptanol, 1-octanol, 2-octanol, 2-ethyl-1-hexanol, benzyl alcohol, ethylene glycol, 1,2-propanediol, 1,3-propanediol, and 2,3-butanediol.

9: The copper paste according to claim 3, wherein
at least one of the first copper particles and the second copper particles has polysaccharides coated on at least a part of their surface.

10: The copper paste according to claim 3, wherein
at least one of the first copper particles and the second copper particles has one or more acids selected from the group comprising octanoic acid, nonanoic acid, decanoic acid, dodecanoic acid, and tetradecanoic acid on at least a part of its surface.

11: The copper paste according to claim 2, wherein the copper powder further comprises:
first copper particles which have an average particle diameter of 50 nm or more and 900 nm or less,
second copper particles which have an average particle diameter of 150 nm or more and 1 μm or less, which are at least 100 nm larger than the average particle diameter of the first copper particles, and
third copper particles that are in a plate-shape, a scaly shape, a flat-shape, or a flaky shape and have an average particle diameter of 1.5 μm or more and 20 μm or less.

12: The copper paste according to claim 11, wherein
the copper powder contains, relative to 100 mass % of the copper powder,
1 mass % or more and 30 mass % or less of the second copper particles, and
5 mass % or more and 60 mass % or less of the third copper particles.

13: The copper paste according to claim 2, wherein
the total amount of the first alcohol and the second alcohol is 5 mass % or more and 50 mass % or less, relative to the total mass of the copper powder, the first alcohol, and the second alcohol, which is 100 mass %.

14: The copper paste according to claim 2, wherein
the paste contains no resin or contains resin in an amount of more than 0 mass % and 10 mass % or less, relative to 100 mass % of the copper powder.

15: The copper paste according to claim 2, which does not contain a silane coupling agent that has an epoxy group and a silane coupling agent that has an amino group, or contains the silane coupling agent that has the epoxy group and the silane coupling agent that has the amino group in an amount of more than 0 mass % and 0.05 mass % or less, relative to 100 mass % of the copper powder.

16: The copper paste according to claim 2, wherein
the first alcohol contains one or more alcohols selected from the group comprising 1-hexanol, 1-heptanol, 2-heptanol, 1-octanol, 2-octanol, 2-ethyl-1-hexanol, benzyl alcohol, ethylene glycol, 1,2-propanediol, 1,3-propanediol, and 2,3-butanediol.
